(19) United States
(12) Patent Application Publication
(10) Pub. No.: US 2025/0146099 A1
(43) Pub. Date: May 8, 2025

(54) REMOVAL OF IMPURITIES CONTAINED IN IRON ORES

(71) Applicant: Form Energy, Inc., Somerville, MA (US)

(72) Inventors: Alex Luyima, Rolla, MO (US); Joseph Stephen Manser, Reading, MA (US)

(73) Assignee: Form Energy, Inc., Somerville, MA (US)

(21) Appl. No.: 18/941,806

(22) Filed: Nov. 8, 2024

Related U.S. Application Data
(60) Provisional application No. 63/547,834, filed on Nov. 8, 2023.

(51) Int. Cl. C22B 1/24; C21B 15/00; C22B 3/10; C22B 3/12; C22B 3/22; C25C 1/06

(52) U.S. Cl. CPC C22B 1/24; C21B 15/00; C22B 3/10; C22B 3/12; C22B 3/22; C25C 1/06

(57) ABSTRACT

A method of removing one or more impurities from an iron-containing feedstock includes grinding the iron-containing feedstock in the presence of a grinding aid to form a pretreated iron-containing feedstock, the grinding aid including an alkali metal chloride, a fluoride salt, or a combination thereof; contacting the pretreated iron-containing feedstock with a flux comprising a metal borate; fusing the pretreated iron-containing feedstock and the flux to form a fused mixture; treating the fused mixture with a leaching solution to form a purified iron-containing feedstock and a used leaching solution; and solid-liquid separating the purified iron-containing feedstock from the used leaching solution, wherein an amount of aluminum, silicon, or a combination thereof is less in the purified iron-containing feedstock than in the iron-containing feedstock. Methods of removing one or more impurities from an iron-containing feedstock also include leaching the pretreated iron-containing feedstock with acid or base without fusion.

### CROSS REFERENCE TO RELATED APPLICATION

This application claims priority to and the benefit of U.S. Provisional Application Ser. No. 63/547,834, filed Nov. 8, 2023, the content of which is incorporated herein by reference in its entirety.

### BACKGROUND

The iron and steel industry is responsible for approximately 10% of global CO₂ emissions and is the largest industrial consumer of coal. In order to meet global energy and climate goals, the steel industry must incorporate emerging near-zero emission steelmaking technologies into its development plan. Alkaline electrowinning of iron ores has been suggested as a more sustainable and less environmentally tasking way of producing metallic iron. However, iron ores can contain various impurities, and some impurities, if not removed, may impair the efficiency of alkaline electrowinning. Additionally, impurities may need to be removed for any process that requires high purity iron ore as feedstock like iron-air batteries. Therefore, there is a continuing need for methods to remove impurities contained in iron ores.

### SUMMARY

A method of removing one or more impurities from an iron-containing feedstock includes: grinding the iron-containing feedstock in the presence of a grinding aid to form a pretreated iron-containing feedstock, the grinding aid including an alkali metal chloride, a fluoride salt, or a combination thereof; contacting the pretreated iron-containing feedstock with a flux including a metal borate; fusing the pretreated iron-containing feedstock and the flux to form a fused mixture; treating the fused mixture with a leaching solution to form a purified iron-containing feedstock and a used leaching solution; and solid-liquid separating the purified iron-containing feedstock from the used leaching solution, wherein an amount of aluminum, silicon, or a combination thereof is less in the purified iron-containing feedstock than in the iron-containing feedstock.

Another method of removing one or more impurities from an iron-containing feedstock includes: grinding the iron-containing feedstock in the presence of a grinding aid to provide a pretreated iron-containing feedstock, the grinding aid comprising an alkali metal chloride, a fluoride salt, or a combination thereof; contacting the pretreated iron-containing feedstock with an acid solution to form a purified iron-containing feedstock and a used acid solution, the acid solution comprising 1 wt % to 10 wt % of an inorganic acid having a pKa of less than −1, an organic acid, or a combination thereof, based on a total weight of the acid solution; and solid-liquid separating the purified iron-containing feedstock from the used acid solution, wherein an amount of aluminum, silicon, or a combination thereof is less in the purified iron-containing feedstock than in the iron-containing feedstock.

Still another method of removing one or more impurities from an iron-containing feedstock includes: grinding the iron-containing feedstock in the presence of a grinding aid to form a pretreated iron-containing feedstock, the grinding aid comprising an alkali metal chloride, a fluoride salt, or a combination thereof; contacting the pretreated iron-containing feedstock with a caustic solution having a hydroxide concentration of at least 30 wt % at a temperature of at least 90° C., preferably at least 150° C. to form a purified iron-containing feedstock and a used caustic solution, the caustic solution and the iron-containing feedstock having a ratio of at least 2.5 mL/g; and solid-liquid separating the purified iron-containing feedstock from the used caustic solution, wherein an amount of aluminum, silicon, or a combination thereof is less in the purified iron-containing feedstock than in the iron-containing feedstock.

### BRIEF DESCRIPTION OF THE DRAWINGS

The following descriptions should not be considered limiting in any way.

FIG. 1 is a schematic flow diagram illustrating an embodiment of a fusion—leaching process to remove impurities from an iron-containing feedstock,

FIG. 2 is a schematic flow diagram illustrating an embodiment of an acid leaching process to remove impurities from an iron-containing feedstock, and

FIG. 3 is a schematic flow diagram illustrating an embodiment of a caustic leaching process to remove impurities from an iron-containing feedstock.

### DETAILED DESCRIPTION

Methods of removing impurities from an iron-containing feedstock are disclosed. The disclosed methods have improved efficiencies and can significantly reduce the amount of Si and Al in the iron-containing feedstock. The purified iron-containing feedstock can be particularly useful in reactions or systems to electrochemically produce iron metal. The purified iron-containing feedstock can also be used in other applications where a high purity iron-containing feedstock is desired.

As used herein, the term “iron metal” refers to Fe(0), which is iron with an oxidation state of zero. “Electrochemically producing iron metal” means that the iron metal is produced via an electrochemical reaction (e.g., electrolytic reduction of an iron oxide) in an electrochemical cell. The term “iron-containing feedstock” refers to an iron-containing material that is capable of undergoing reduction during operation of an electrochemical cell to generate iron metal. For convenience, the term “iron ore” may be substituted or interchanged for the term “iron-containing feedstock.”

Natural iron ores are typically associated with gangue minerals. These can include, among others, quartz, SiO₂; kaolinite, Al₄(Si₄O₁₀)(OH)₈; gibbsite, Al(OH)₃; minnesotaite, (Mg,Fe)₃Si₄O₁₀(OH)₂; orthoclase, KAlSi₃O₈; stilpnomelane, (K,Na,Ca)_{0.6}(Mg,Fe²⁺, Fe³⁺)₆Si₈Al(O,OH)₂₄·2H₂O; albite, NaAlSi₃O₈; and pyrolusite, MnO₂. (See Iron ore: Mineralogy, processing and environmental sustainability by Woodhead Publishing, 2015. ISBN 978-1-78242-156-6, the content of which is included herein by reference for all purposes). Some of these impurities may be removed using gravity concentration, magnetic separation, flotation, or leaching. However, impurities can be trapped in the iron ores, thus making them difficult to remove. Trapped impurities are a challenge to electrochemically producing iron metal because the composition of the iron ore feedstock can have a direct impact on the purity of the produced iron metal. In addition, impurities such as kaolinite, gibbsite, or quartz can dissolve in concentrated NaOH solutions that are used in alkaline electrolysis to produce iron metal. The dissolved impurities may react to form insoluble compounds (e.g., sodium aluminosilicates) that can passivate the electrodes, and hence impact the current efficiency of production of the iron metal.

The inventors have found that grinding the iron-containing feedstock in the presence of a grinding aid (an alkali metal chloride, a fluoride salt, or a combination thereof) can release the impurities such as silica and alumna (e.g., in the form of silica or alumina grains) from a matrix of the iron-containing feedstock and facilitate the removal of the impurities. As used herein, a matrix can mean particles or other solid forms of the iron-containing feedstock. Once released, the impurities can be readily leached out, thus greatly improving the process efficiency. In addition, grinding the iron-containing feedstock in the presence of the grinding aid as described herein can make the feedstock less sticky. A less sticky feedstock does not coat the inside of the equipment used during grinding, reducing material waste and avoiding downtime to clean the equipment. The use of the grinding aid as described herein can also reduce the attraction forces among the finely ground particles thus mitigating the agglomeration and improving the efficiency of the post grinding leaching process.

The grinding aid may comprise an alkali metal chloride, a fluoride salt, or a combination thereof. The alkali metal chloride can include lithium chloride, sodium chloride, potassium chloride, cesium chloride, or a combination thereof. The fluoride salt can include ammonium fluoride, an alkali metal fluoride such as lithium fluoride; sodium fluoride; potassium fluoride; or cesium fluoride, an alkaline earth metal fluoride such as magnesium fluoride and calcium fluoride, or a combination thereof. Preferably the grinding aid is sodium chloride, sodium fluoride, or a combination thereof, and more preferably the grinding aid is sodium chloride.

The grinding aid is preferably used as a solid during grinding. In other words, the iron-containing feedstock is ground in the presence of a solid grinding aid. The average particle size of the grinding aid can be 1 micron (μm) to 5,000 μm, preferably 45 μm to 1,000 μm, and more preferably 75 μm to 425 μm. As used herein, an average particle size refers to a number average particle size, and can be determined by laser diffraction, dynamic light scattering, or image analysis, for example as determined with a HORIBA particle size analyzer.

Any suitable iron ore may be used. In an aspect, the iron-containing feedstock comprises hematite, maghemite, magnetite, goethite, limonite, or a combination thereof. A weight ratio of the grinding aid to the iron-containing feedstock can be 1:8 to 1:1, preferably 1:6 to 1:2, 1:5.5 to 1:2.5, 1:5 to 1:3, or 1:45 to 1:1.35, depending on the specific iron-containing feedstock used.

The grinding can be conducted at a temperature of 15° C. to 40° C., 18° C. to 25° C., or room temperature. Preferably the grinding is a dry grinding where no solvent is intentionally added during grinding. The equipment for carrying out the dry grinding is known by or can be determined by those of skill in the art without undue experimentation, and is not particularly limited.

The grinding can reduce the particle size of the iron-containing feedstock, and release one or more impurities such as silica, alumina, or a combination thereof from a matrix of the feedstock to provide a pretreated iron-containing feedstock. The pretreated iron-containing feedstock can include iron-containing feedstock particles having an average particle size of 10 μm to 300 μm, preferably 10 μm to 250 μm. The pretreated iron-containing feedstock, which includes the grinding aid, can be used directly in the leaching process.

After grinding, one or more impurities may be removed from the iron-containing feedstock by a fusion—leaching process, an acid leaching process, a caustic leaching process, or a combination thereof. As used herein, leaching refers to a process that converts one or more impurities in a feedstock to soluble species in a leaching solution.

### Fusion—Leaching

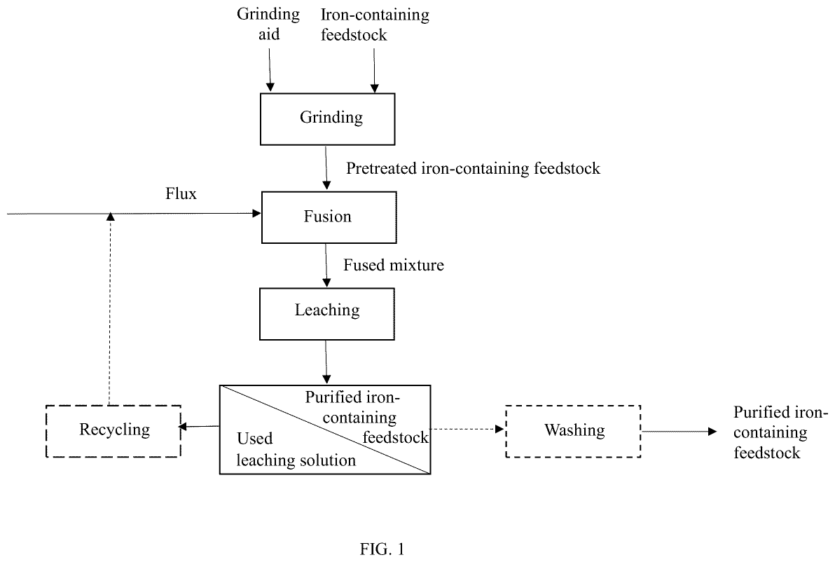

The pretreated iron-containing feedstock can be purified by a fusion—leaching process as shown in FIG. 1. As shown, the particles in the pretreated iron-containing feedstock can be fused with a flux to form a fused mixture, and the fused mixture can be leached with water, an acidic aqueous solution, or a basic aqueous solution to remove one or more impurities from the iron-containing feedstock.

The flux can comprise a metal borate. The metal of the metal borate can be an alkali metal, an alkaline earth metal, or a combination thereof, and preferably the metal of the metal borate is sodium. The metal borate may be hydrated or anhydrous, wherein an anhydrous metal borate is preferred. Examples of the metal borate include Na₃BO₃, Na₃B₃O₆, NaB(OH)₄, Na₂B₄O₇, Na₂B₄O₇·4H₂O, Na₂B₄O₇·5H₂O, Na₂B₄O₇·10H₂O, Na₂B₈O₁₃, or a combination thereof.

Optionally the flux can further include a second fluoride salt, a second chloride salt, a hydroxide, or a combination thereof. The second fluoride salt and the second chloride salt can be the same or different from the alkali metal chloride and the fluoride salt used during the grinding. Preferably, the grinding aid in the pretreated iron containing feedstock and the flux together include a combination of a chloride salt and a fluoride salt. For example, if a chloride salt (e.g. NaCl, KCl, or a combination thereof) is used as a grinding acid, the flux can include a fluoride salt (e.g., NaF, KF, or a combination thereof), and vice versa such that both a chloride salt and a fluoride salt are present during fusion.

The second chloride salt can include ammonium chloride, an alkali metal chloride such as lithium chloride; sodium chloride; potassium chloride; or cesium chloride, an alkaline earth metal chloride such as magnesium chloride; calcium chloride; or barium chloride, or a combination thereof. The second fluoride salt can include ammonium fluoride, an alkali metal fluoride such as lithium fluoride; sodium fluoride; potassium fluoride; or cesium fluoride, an alkaline earth metal fluoride such as magnesium fluoride and calcium fluoride, or a combination thereof. The hydroxide can include sodium hydroxide, potassium hydroxide, lithium hydroxide, cesium hydroxide, ammonium hydroxide, or a combination thereof.

A weight ratio of the flux to the pretreated iron-containing feedstock can be less than or equal to 1.5:1, preferably 0.25:1 to 1.5:1. In an aspect, a weight ratio of a sum of the amounts of the flux and the grinding aid to the pretreated iron-containing feedstock particles can be less than or equal to 1.5:1, preferably 0.25:1 to 1.5:1.

The pretreated iron-containing feedstock can contact or preferably mix with the flux in a mixer or a mixer-blender, then be transferred to a crucible where the particles of the pretreated iron-containing feedstock and the flux are fused to form a fused mixture. The fusing can take place at a temperature of 323° C. to 1500° C. for 1 hour to 24 hours, depending on the phase and structure of the impurities, the iron-containing feedstock used, the flux, or a combination of these factors.

The fused mixture can be leached in an aqueous solution such as water, an acidic solution, or a basic aqueous solution to release (e.g., dissolve) the impurities into the solution.

In a water leaching process, the fused mixture can be treated with water at a temperature of 25-300° C., preferably 40-100° C. (water leaching temperature), with a water to solid (fused mixture) ratio of 4 milliliters per gram (mL/g) to 15 mL/g. For example, the fused mixture can be washed with water having the water leaching temperature, or stirred in water at the water leaching temperature to provide a purified iron-containing feedstock, and a used water.

In an acid leaching process, the fused mixture can be treated with an acidic aqueous solution. The acidic aqueous solution can comprise hydrofluoric acid (HF), hydrochloric acid (HCl), nitric acid (HNO₃), sulfuric acid (H₂SO₄), acetic acid, citric acid, oxalic acid, or a combination thereof. The concentration of the acid can be 1 weight percent (wt %) to 10 wt %, 1 wt % to 5 wt %, or 1 wt % to 2 wt %, each based on a total weight of the acidic aqueous solution. As a specific example, the acidic aqueous solution contains 1 wt % to 2 wt % of HCl and 1 wt % to 10 wt % HF, each based on a total weight of the acidic aqueous solution.

The ratio of the acidic aqueous solution to the fused mixture (liquid to solid ratio) can be 4 mL/g to 15 mL/g. The fused mixture can be treated with the acidic aqueous solution at a temperature of 25° C. to 300° C., preferably 40° C. to 100° C. For example, the fused mixture can be stirred in the acidic aqueous solution at the acid leaching temperature for 30 minutes to 24 hours, or washed with the acidic aqueous solution having the acid leaching temperature to form a purified iron-containing feedstock, and a used acidic aqueous solution.

The leaching solution can also be a basic aqueous solution. The basic aqueous solution can comprise a hydroxide such as sodium hydroxide, potassium hydroxide, lithium hydroxide, cesium hydroxide, ammonium hydroxide, or a combination thereof. A concentration of the hydroxide can be at least 30 wt %, for example 30 wt % to 70 wt %, 30 wt % to 60 wt %, or 30 wt % to 50 wt %, based on a total weight of the caustic solution. The ratio of the basic aqueous solution to the fused mixture (liquid to solid ratio) can be 4 mL/g to 15 mL/g. The fused mixture can be treated with the basic aqueous solution at a temperature of at least 90° C., preferably at least 150° C., more preferably 150° C. to 300° C. For example, the fused mixture can be stirred in the basic aqueous solution at the caustic leaching temperature for 30 minutes to 24 hours, or washed with the basic aqueous having the caustic leaching temperature to form a purified iron-containing feedstock, and a used basic aqueous solution.

The purified iron-containing feedstock can be isolated by solid-liquid separation techniques such as filtration, and then optionally water washed and dried. One or more components of the flux can be recycled from the used water, the used acidic aqueous solution, and/or the used basic aqueous solution via precipitation and solid-liquid separation. The recovered flux components can be used in another purification cycle.

An exemplary fusion—leaching process is as follows. An iron-containing feedstock is initially ground in the presence of a grinding aid (e.g., solid NaCl) to form a pretreated iron-containing feedstock comprising pretreated ion-containing feedstock particles having an average particle size ranging from 10 to 300 microns and the grinding aid. The pretreated iron-containing feedstock is then mixed with a flux (e.g., a borax such as Na₂H₂OB₄O₁₇+NaF) in a mixer or mixer-blender at a flux to feedstock weight ratio of less than 1.5. The borax may be sodium borate, sodium tetraborate, disodium borate, or any other borax compound as disclosed herein. The mixture may be transferred into a heating crucible and heated at the desired temperature (323° C. to 1500° C.) for 1 hour to 24 hours to form a fused mixture. The fused mixture can be leached (e.g. washed or stirred) with hot water (40° C. to 100° C.) at a solid/liquid ratio (fused mixture/hot water ratio) of 4 mL/g to 15 mL/g to release (e.g., dissolve) the impurities into solution, forming a purified iron-containing feedstock. The purified iron-containing feedstock is separated, washed with water, and dried.

### Acid Leaching

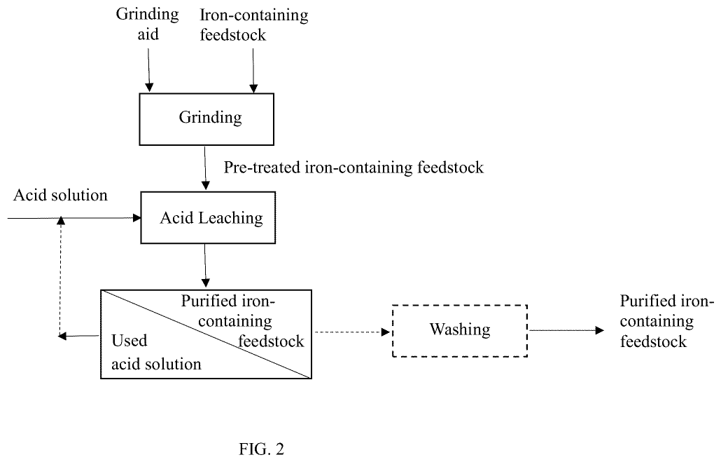

Instead of fusion—leaching, the pretreated iron-containing feedstock can also be leached with a strong acid as shown in FIG. 2 without fusion. The strong acid can be an acid solution comprising 1 wt % to 20 wt %, preferably 5 wt % to 15 wt % or 8 wt % to 12 wt % of an inorganic acid having a pKa of less than −1, an organic acid, or a combination thereof, based on a total weight of the acid solution. The acid having a pKa of less than −1 can include hydrochloric acid, nitric acid, sulfuric acid, or a combination thereof. The organic acid can include acetic acid, citric acid, oxalic acid, or a combination thereof.

A weight ratio of the acid solution to the pretreated iron-containing feedstock can be 5:1 to 10,000:1, preferably 10:1 to 5,000:1, 5:1 to 1,000:1, 5:1 to 100:1, or 5:1 to 20:1. The acid solution can contact the pretreated iron-containing feedstock at a temperature of 25° C. to 300° C., preferably 40° C. to 150° C., 60° C. to 120° C., 70° C. to 110° C., or 80° C. to 100° C. for 30 minutes to 24 hours, 2 hours to 15 hours, or 6 hours to 10 hours to form a purified iron-containing feedstock and a used acid solution.

As a specific example, the acid solution can be an aqueous solution of hydrochloric acid having a concentration of 5 wt % to 15 wt % or 8 wt % to 12 wt % based on a total weight of the acid solution. A weight ratio of the hydrochloric acid aqueous solution to the pretreated iron-containing feedstock can be 5:1 to 100:1 or 5:1 to 20:1. And the hydrochloric aqueous solution can contact the pretreated iron-containing feedstock at a temperature of 60° C. to 120° C., 70° C. to 110° C., or 80° C. to 100° C., and optionally for 2 hours to 15 hours, or 6 hours to 10 hours to form a purified iron-containing feedstock and a used acid solution.

The purified iron-containing feedstock can be separated from the used acid solution via a solid-liquid separation method. Any known solid-liquid separation techniques can be used. For example, the purified iron-containing feedstock can be separated from the used acid solution via filtration, then optionally water (e.g., deionized water) washed and dried. The used acid solution can be recycled and used to leach an unpurified iron-containing feedstock.

### Caustic Leaching

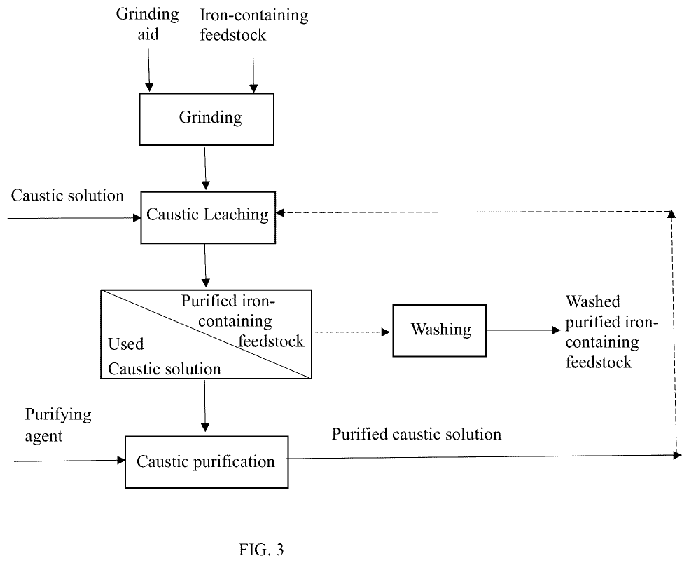

The pretreated iron-containing feedstock can also be leached with a base as shown in FIG. 3 without fusion. Applicant has found that even without the fusion as discussed herein, caustic leaching under a specific combination of conditions can also effectively purify the pretreated ion-containing feedstock. The conditions include contacting the pretreated iron-containing feedstock with a caustic solution containing a hydroxide having a concentration of at least 30 wt %, for example 30 wt % to 70 wt %, 30 wt % to 60 wt %, or 40 wt % to 60 wt %, or 45 wt % to 55 wt %, based on a total weight of the caustic solution. at a temperature of at least 90° C., preferably at least 120° C., or at least 140° C., more preferably 120° C. to 300° C., 140° C. to 300° C., or 140° C. to 200° C. at a liquid/solid ratio (feedstock/caustic solution ratio) of at least 2.5 mL/g, for example 2.5 mL/g to 10 mL/g or 3 mL/g to 8 mL/g, or 4 mL/g to 7 mL/g. The treatment time can vary from 20 minutes to 10 hours, 30 minutes to 8 hours, or 30 minutes to 4 hours, based on the concentration of the hydroxide and the treatment temperature. The hydroxide of the caustic solution can comprise sodium hydroxide, potassium hydroxide, lithium hydroxide, cesium hydroxide, ammonium hydroxide, or a combination thereof. For example, the caustic solution can be an aqueous solution of sodium hydroxide having a concentration of 30 wt % to 60 wt %, or 40 wt % to 60 wt %, or 45 wt % to 55 wt %, based on a total weight of the caustic solution, and the pretreated iron-containing feedstock can be contract with this sodium hydroxide aqueous solution at a temperature of 120° C. to 300° C., 140° C. to 300° C., or 140° C. to 200° C., optionally at a liquid/solid ratio of 3 mL/g to 8 mL/g, or 4 mL/g to 7 mL/g. The iron-containing feedstock has an average particle size of 10 μm to 300 μm, preferably 10 μm to 250 μm. After the pretreated iron-containing feedstock is contacted with the caustic solution under the conditions as described herein, one or more impurities in the iron-containing feedstock can be leached into the caustic solution, generating a purified iron-containing feedstock, and a used caustic solution.

The purified iron-containing feedstock can be separated from the used caustic solution by any known solid-liquid separation techniques. For example, the purified iron-containing feedstock can be filtered, then optionally washed with water (e.g., deionized water), and dried.

The used caustic solution can be purified to form a purified caustic solution before being used in another purification cycle. Accordingly, the method can further include recovering the used caustic solution after the contacting with the iron-containing feedstock to provide a recovered caustic solution. The recovered caustic solution can be purified to form a purified caustic solution, which can be used to leach the iron-containing feedstock. To purified the recover caustic solution, the recovered caustic solution is contacted with a purifying agent including Al₂O₃, Al(OH)₃, CaO, Ca(OH)₂, an aluminate compound, or a combination thereof. Examples of the aluminate compound can include NaAlO₂, Al₂Si₂O₅(OH)₄, NaAl(OH)₄, Na₂O·Al₂O₃, Na₂Al₂O₄, or a combination thereof.

### Purified Iron-Containing Feedstock and Applications

The methods as described herein are cost effective and can turn the low-grade commercial iron ores and ore concentrates into iron-containing feedstocks having the desired specification.

The purified iron-containing feedstock can comprise at least 10 wt % less aluminum, at least 20 wt % less aluminum, at least 30 wt % less aluminum, at least 40 wt % less aluminum, at least 50 wt % less aluminum, at least 60 wt % less aluminum, or at least 70 wt % less aluminum than the iron-containing feedstock, based on a total weight of the aluminum in the iron-containing feedstock. Alternatively, or in addition, the purified iron-containing feedstock can comprise at least 10 wt % less silicon, at least 20 wt % less silicon, at least 30 wt % less silicon, at least 40 wt % less silicon, at least 50 wt % less silicon, at least 60 wt % less silicone, or at least 70 wt % less silicon than the iron-containing feedstock, based on a total weight of the silicon in the iron-containing feedstock. Alternatively, or in addition, a total content of silicon and aluminum in the purified iron-containing feedstock is less than or equal to 6 wt %, less than or equal to 5 wt %, less than or equal to 3 wt %, less than or equal to 2 wt %, less than or equal to 1.8 wt %, less than or equal to 1.7 wt %, less than or equal to 1.6 wt %, less than or equal to 1.5 wt %, less than or equal to 1.4 wt %, less than or equal to 1.3 wt %, less than or equal to 1.2 wt %, less than or equal to 1.1 wt %, less than or equal to 1 wt %, less than or equal to 0.9 wt %, less than or equal to 0.8 wt %, less than or equal to 0.7 wt %, less than or equal to 0.6 wt %, less than or equal to 0.5 wt %, less than or equal to 0.4 wt %, less than or equal to 0.3 wt %, less than or equal to 0.2 wt %, less than or equal to 0.1 wt %, each based on a total weight of the purified iron-containing feedstock. A total content of silicon and aluminum in the purified iron-containing feedstock can be greater than or equal to 0.01 wt %, greater than greater than or equal to 0.02 wt %, greater than or equal to 0.03 wt %, greater than or equal to 0.04 wt %, or greater than or equal to 0.05 wt %, greater than or equal to 0.1 wt %, greater than or equal to 0.2 wt %, greater than or equal to 0.3 wt %, greater than or equal to 0.4 wt %, greater than or equal to 0.5 wt %, or greater than or equal to 0.6 wt %, each based on a total weight of the purified iron-containing feedstock. Alternatively, or in addition, the purified iron-containing feedstock can have a silicon content of less than 5 wt % or less than 4.5 wt %, or less than 2 wt %, an aluminum content of less than 0.05 wt %, or a combination thereof, where the silicon content and the aluminum content are each based on a total weight of the purified iron-containing feedstock. Alternatively, or in addition, the purified iron-containing feedstock can have a manganese content of less than 0.55 wt % based on a total weight of the purified iron-containing feedstock.

The purified iron-containing feedstock can be used in various applications where high purity iron-containing feedstock is desired. The purified iron-containing feedstock as prepared with the methods as described herein can be particularly useful for the production of iron metal via electrochemical processes.

Methods of producing iron metal from the purified iron-containing feedstock can include flowing an electrolyte stream comprising the purified iron-containing feedstock and an electrolyte (e.g. an aqueous solution of an alkali hydroxide, ammonium hydroxide, or a combination thereof) through an electrochemical cell comprising an anode and a cathode, applying a magnetic field to the cathode, and electrochemically reducing at least a portion of the purified iron-containing feedstock to produce an iron particle at the surface of the cathode while the magnetic field is applied at the cathode. The method can further include reducing a voltage applied to the electrochemical cell to stop the electrochemical reduction of the purified iron-containing feedstock, decreasing or removing the magnetic field at the cathode, or a combination thereof, and contacting the surface of the cathode with the electrolyte stream to flush the iron particle from the cathode. Thus, with the purification methods disclosed herein, iron metal can be continuously produced in a powder-to-powder electrochemical process from low-grade iron ore, which may provide steel production at reduced cost while reducing the carbon dioxide emissions or carbon footprint.

The iron metal produced from the purified iron-containing feedstock can have (i) a specific total embedded emissions of less than 0.8 tons of CO₂ per ton of the iron metal, when determined according to the European Union simplified bubble approach method for determining specific embedded emissions under the Carbon Border Adjustment Mechanism; (ii) a carbon emission intensity of less than 1100 kilograms of CO₂ per ton of the iron metal, when determined according to ISO 14404; (iii) a carbon emission intensity of less than 800 kilograms of CO₂ per ton of the iron metal, when determined according to the Intergovernmental Panel on Climate Change Methodology 2006 Guidelines for National Greenhouse Gas Inventories; (iv) a carbon emission intensity of less than 1500 kilograms of CO₂ per ton of the iron metal, when determined according to the 2017 World Steel Life Cycle Inventory Methodology; (v) a carbon emission intensity of less than 1300 kilograms of CO₂ per ton of the iron metal, when determined according to the 2008 World Resource Institute Iron and Steel Greenhouse Gas Protocol; (vi) a carbon emission intensity of less than 750 kilograms of CO₂ per ton of the iron metal, when determined according to European Union Commission Implementing Regulation 2018/2066; (vii) a specific total embedded emissions of less than 0 tons of CO₂ per ton of the iron metal, when determined according to the European Union simplified bubble approach method for determining specific embedded emissions under the Carbon Border Adjustment Mechanism, or (viii) a combination thereof.

The methods of removing impurities from iron-containing feedstocks are further illustrated by the following non-limiting examples.

### EXAMPLES

### Example 1

A natural iron ore was combined with NaCl in a mass ratio of 1:1 NaCl:ore. The mixture was ball milled at 300 Hz for 0.83 hrs. The mixture was treated with a 10 wt % HCl solution at 90° C. and stirred using a magnetic stir bar at 300 RPM for 8 hours. The weight ratio of the acid solution to the milled mixture was 10:1. Once cool, the ore was filtered with an excess of deionized water, and solids were dried in an oven at 105° C. for 24 hours. The composition was analyzed using wavelength dispersive X-ray fluorescence (WD-XRF), and the results are summarized in Table 1 below.

### Example 2

A natural iron ore was combined with NaCl in a mass ratio of 1:4 NaCl:ore. The mixture was ball milled at 300 Hz for 0.83 hrs. The mixture was treated with a 10 wt % HCl solution at 90° C. and stirred using a magnetic stir bar at 300 RPM for 8 hours. The weight ratio of the acid solution to the milled mixture was 10:1. Once cool, the ore was filtered with an excess of deionized water, and solids were dried in an oven at 105° C. for 24 hours. The composition was analyzed using WD-XRF, and the results are summarized in Table 1 below.

### Example 3

A natural iron ore was combined with NaCl in a mass ratio of 1:1 NaCl:ore. The mixture was ball milled at 300 Hz for 0.83 hrs. The mixture was treated with a 50 wt % NaOH solution at 150° C. in an autoclave and stirred using an overhead mixer at 500 RPM for 2 hours. The weight ratio of the solution to the milled mixture was 5 mL/g. Once cool, the ore was filtered with an excess of deionized water, and solids were dried in an oven at 105° C. for 24 hours. The composition was analyzed using WD-XRF, and the results are summarized in Table 1 below.

### Example 4

A natural iron ore was combined with NaCl in a mass ratio of 1:8 NaCl:ore. The mixture was ball milled at 300 Hz for 0.83 hrs. The mixture was treated with a 50 wt % NaOH solution at 150° C. in an autoclave and stirred using an overhead mixer at 500 RPM for 2 hours. The weight ratio of the solution to the milled mixture was 5 mL/g. Once cool, the ore was filtered with an excess of deionized water, and solids were dried in an oven at 105° C. for 24 hours. The composition was analyzed using WD-XRF, and the results are summarized in Table 1 below.

TABLE 1

| | Grinding | GA:Ore | | Temp. | Time | Fe | Si | Al | Mn |
|---|---|---|---|---|---|---|---|---|---|
| Example | Aid | Ratio | Leach | (° C.) | (hr) | (wt %) | (wt %) | (wt %) | (wt %) |
| Control | — | — | — | — | — | 59.18 | 4.91 | 1.45 | 0.55 |
| 1 | NaCl | 1:1 | 10 wt % HCl | 90 | 8 | 58.54 | 6.54 | 0.49 | — |
| 2 | NaCl | 1:4 | 10 wt % HCl | 90 | 8 | 61.67 | 4.42 | 0.34 | — |
| 3 | NaCl | 1:1 | 50 wt % | 150 | 2 | 67.06 | 0.53 | 0.12 | 0.46 |
| | | | NaOH | | | | | | |
| 4 | NaCl | 1:8 | 50 wt % | 150 | 2 | 62.67 | 1.28 | 0.18 | 0.53 |
| | | | NaOH | | | | | | |

1. Control refers to the untreated natural iron ore.
2. GA refers to the grinding aid.

This disclosure further encompasses the following aspects.

Aspect 1. A method of removing one or more impurities from an iron-containing feedstock, the method comprising: grinding the iron-containing feedstock in the presence of a grinding aid to form a pretreated iron-containing feedstock, the grinding aid comprising an alkali metal chloride, a fluoride salt, or a combination thereof, preferably the grinding acid comprising an alkali metal chloride, and more preferably the grinding aid comprising sodium chloride; contacting the pretreated iron-containing feedstock with a flux comprising a metal borate; fusing the pretreated iron-containing feedstock and the flux to form a fused mixture; treating the fused mixture with a leaching solution to form a purified iron-containing feedstock and a used leaching solution; and solid-liquid separating the purified iron-containing feedstock from the used leaching solution, wherein an amount of aluminum, silicon, or a combination thereof is less in the purified iron-containing feedstock than in the iron-containing feedstock.

Aspect 2. The method of Aspect 1, wherein a weight ratio of the flux to the pretreated iron-containing feedstock is less than or equal to 1.5:1, preferably 0.25:1 to 1.5:1.

Aspect 3. The method of any of the preceding Aspects, wherein the metal of the metal borate is an alkali metal, an alkaline earth metal, or a combination thereof.

Aspect 4. The method of any of the preceding Aspects, wherein the metal borate is Na₃BO₃, Na₃B₃O₆, NaB(OH)₄, Na₂B₄O₇, Na₂B₄O₇·4H₂O, Na₂B₄O₇·5H₂O, Na₂B₄O₇·10H₂O, Na₂B₈O₁₃, or a combination thereof.

Aspect 5. The method of any of the preceding Aspects, wherein the flux further comprises a second fluoride salt, a second chloride salt, a hydroxide, or a combination thereof, and optionally wherein the second fluoride salt is ammonium fluoride, an alkali metal fluoride, an alkaline earth metal fluoride, or a combination thereof, and the second chloride salt is ammonium chloride, an alkali metal chloride, an alkaline earth metal chloride, or a combination thereof.

Aspect 6. The method of any of the preceding Aspects, wherein the fusing comprises heating at a temperature of 323° C. to 1500° C. for 1 hour to 24 hours.

Aspect 7. The method of any of Aspects 1 to 6, wherein the leaching solution is water, and preferably wherein the leaching solution is water at a temperature of 25° C. to 300° C.

Aspect 8. The method of any of Aspects 1 to 6, wherein the leaching solution is an acidic aqueous solution.

Aspect 9. The method of Aspect 8, wherein the acidic aqueous solution comprises hydrofluoric acid, hydrochloric acid, nitric acid, sulfuric acid, acetic acid, citric acid, oxalic acid, or a combination thereof.

Aspect 10. The method of any of Aspects 1 to 6, wherein the leaching solution is a basic aqueous solution.

Aspect 11. The method of Aspect 10, wherein the basic aqueous solution comprises sodium hydroxide, potassium hydroxide, lithium hydroxide, cesium hydroxide, ammonium hydroxide, or a combination thereof.

Aspect 12. The method of any of the preceding Aspects, further comprising recycling one or more components of the flux from the used leaching solution.

Aspect 13. A method of removing one or more impurities from an iron-containing feedstock, the method comprising: grinding the iron-containing feedstock in the presence of a grinding aid to provide a pretreated iron-containing feedstock, the grinding aid comprising an alkali metal chloride, a fluoride salt, or a combination thereof, preferably the grinding acid comprising an alkali metal chloride, and more preferably the grinding aid comprising sodium chloride; contacting the pretreated iron-containing feedstock with an acid solution to form a purified iron-containing feedstock and a used acid solution, the acid solution comprising 1 wt % to 20 wt % of an inorganic acid having a pKa of less than −1, an organic acid, or a combination thereof, based on a total weight of the acid solution; and solid-liquid separating the purified iron-containing feedstock from the used acid solution, wherein an amount of aluminum, silicon, or a combination thereof is less in the purified iron-containing feedstock than in the iron-containing feedstock.

Aspect 14. The method of Aspect 13, wherein a weight ratio of the acid solution to the pretreated iron-containing feedstock is 5:1 to 10,000:1, 5:1 to 1,000:1, 5:1 to 100:1, or 5:1 to 20:1.

Aspect 15. The method of any of Aspects 13 to 14, wherein the contacting is at a temperature of 25° C. to 300° C., preferably 40° C. to 150° C., 60° C. to 120° C., 70° C. to 110° C., or 80° C. to 100° C. for 30 minutes to 24 hours, 2 hours to 15 hours, or 6 hours to 10 hours.

Aspect 16. The method of any of Aspects 13 to 15, wherein the acid solution comprises hydrochloric acid, nitric acid, sulfuric acid, acetic acid, citric acid, oxalic acid, or a combination thereof, preferably the acid solution comprises an aqueous solution of hydrochloric acid, and more preferably the acid solution comprises an aqueous solution of hydrochloric acid having a concentration of 5 wt % to 15 wt % or 8 wt % to 12 wt % based on a total weight of the acid solution.

Aspect 17. The method of any of Aspects 13 to 16, further comprising recycling the used acid solution for contacting with a second pretreated iron-containing feedstock.

Aspect 18. A method of removing one or more impurities from an iron-containing feedstock, the method comprising: grinding the iron-containing feedstock in the presence of a grinding aid to form a pretreated iron-containing feedstock, the grinding aid comprising an alkali metal chloride, a fluoride salt, or a combination thereof, preferably the grinding acid comprising an alkali metal chloride, and more preferably the grinding aid comprising sodium chloride; contacting the pretreated iron-containing feedstock with a caustic solution having a hydroxide concentration of at least 30 wt % (e.g., 30 wt % to 70 wt %, 30 wt % to 60 wt %, or 40 wt % to 60 wt %, or 45 wt % to 55 wt %), based on a total weight of the caustic solution, at a temperature of at least 90° C., preferably at least 140° C. (e.g., 120° C. to 300° C., 140° C. to 300° C., or 140° C. to 200° C.) to form a purified iron-containing feedstock and a used caustic solution, the caustic solution and the iron-containing feedstock having a ratio of at least 2.5 mL/g (e.g., 3 mL/g to 8 mL/g, or 4 mL/g to 7 mL/g); and solid-liquid separating the purified iron-containing feedstock from the used caustic solution, wherein an amount of aluminum, silicon, or a combination thereof is less in the purified iron-containing feedstock than in the iron-containing feedstock.

Aspect 19. The method of Aspect 18, wherein the contacting is at a temperature of 140° C. to 300° C. for 30 minutes to 24 hours.

Aspect 20. The method of any of Aspects 18 to 19, wherein the caustic solution comprises sodium hydroxide, potassium hydroxide, lithium hydroxide, cesium hydroxide, ammonium hydroxide, or a combination thereof.

Aspect 21. The method of any of Aspects 18 to 20, further comprising purifying the used caustic solution to form a purified caustic solution before further contacting the purified caustic solution with the pretreated iron-containing feedstock.

Aspect 22. The method of Aspect 21, wherein the purifying comprises contacting the used caustic solution with Al₂O₃, Al(OH)₃, CaO, Ca(OH)₂, an aluminate compound, or a combination thereof; and optionally wherein the aluminate compound comprises NaAlO₂, Al₂Si₂O₅(OH)₄, NaAl(OH)₄, Na₂O·Al₂O₃, Na₂Al₂O₄, or a combination thereof.

Aspect 23. The method of any of the preceding Aspects, wherein the alkali metal chloride in the grinding aid is lithium chloride, sodium chloride, potassium chloride, cesium chloride, or a combination thereof; and the fluoride salt in the grinding aid is ammonium fluoride, an alkali metal fluoride, an alkaline earth metal fluoride, or a combination thereof, and preferably wherein the grinding aid comprises sodium chloride, sodium fluoride, or a combination thereof.

Aspect 24. The method of any of the preceding Aspects, wherein the grinding aid is solid sodium chloride.

Aspect 25. The method of any of the preceding Aspects, wherein a weight ratio of the grinding aid to the iron-containing feedstock is 1:8 to 1:1, preferably 1:6 to 1:2 or 1:5 to 1:3.

Aspect 26. The method of any of the preceding Aspects, wherein the grinding releases one or more impurities from a matrix of the iron-containing feedstock.

Aspect 27. The method of any of the preceding Aspects, wherein the pretreated iron-containing feedstock comprises iron-containing feedstock particles having an average particle size of 10 μm to 300 μm, preferably 10 μm to 250 μm.

Aspect 28. The method of any of the preceding Aspects, wherein the iron-containing feedstock comprises hematite, maghemite, magnetite, goethite, limonite, or a combination thereof

Aspect 29. The method of any of the preceding Aspects, further comprising washing the purified iron-containing feedstock with an aqueous solution.

Aspect 30. The method of any of the preceding Aspects, wherein (i) the purified iron-containing feedstock comprises at least 10 weight percent less aluminum than the iron-containing feedstock, based on a total weight of the aluminum in the iron-containing feedstock; (ii) the purified iron-containing feedstock comprises at least 10 weight percent less silicon than the iron-containing feedstock, based on a total weight of the silicon in the iron-containing feedstock; (iii) a total content of silicon and aluminum in the purified iron-containing feedstock is less than or equal to 6 wt %, less than or equal to 5 wt %, or less than or equal to 2 wt %, preferably 0.01 wt % to 1.8 wt %, based on a total weight of the purified iron-containing feedstock; or (iv) a combination thereof.

Aspect 31. A purified iron-containing feedstock, prepared by the method of any of the preceding Aspects.

Aspect 32. A method comprising: removing one or more impurities from an iron-containing feedstock to form a purified iron-containing feedstock by the method of any of Aspects 1 to 30; and electrochemically producing an iron metal from the purified iron-containing feedstock.

Aspect 33. The method of Aspect 32, wherein the iron metal has a specific total embedded emissions of less than 0.8 tons of CO₂ per ton of the iron metal, when determined according to the European Union simplified bubble approach method for determining specific embedded emissions under the Carbon Border Adjustment Mechanism; a carbon emission intensity of less than 1100 kilograms of CO₂ per ton of the iron metal, when determined according to ISO 14404; a carbon emission intensity of less than 800 kilograms of CO₂ per ton of the iron metal, when determined according to the Intergovernmental Panel on Climate Change Methodology 2006 Guidelines for National Greenhouse Gas Inventories; a carbon emission intensity of less than 1500 kilograms of CO₂ per ton of the iron metal, when determined according to the 2017 World Steel Life Cycle Inventory Methodology; a carbon emission intensity of less than 1300 kilograms of CO₂ per ton of the iron metal, when determined according to the 2008 World Resource Institute Iron and Steel Greenhouse Gas Protocol; a carbon emission intensity of less than 750 kilograms of CO₂ per ton of the iron metal, when determined according to European Union Commission Implementing Regulation 2018/2066; a specific total embedded emissions of less than 0 tons of CO₂ per ton of the iron metal, when determined according to the European Union simplified bubble approach method for determining specific embedded emissions under the Carbon Border Adjustment Mechanism, or a combination thereof.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, which are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %,” is inclusive of the endpoints and all intermediate values of the ranges of “5 wt % to 25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments,” “an embodiment,” “an aspect,” and so forth, means that a particular element described in connection with the embodiment and/or aspect is included in at least one embodiment and/or aspect described herein, and may or may not be present in other embodiments and/or aspects. In addition, it is to be understood that the described elements may be combined in any suitable manner in the various embodiments and/or aspects. A “combination thereof” is open and includes any combination comprising at least one of the listed components or properties optionally together with a like or equivalent component or property not listed.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art.

1. A method of removing one or more impurities from an iron-containing feedstock, the method comprising:
grinding the iron-containing feedstock in the presence of a grinding aid to form a pretreated iron-containing feedstock, the grinding aid comprising an alkali metal chloride, a fluoride salt, or a combination thereof;
contacting the pretreated iron-containing feedstock with a flux comprising a metal borate;
fusing the pretreated iron-containing feedstock and the flux to form a fused mixture;
treating the fused mixture with a leaching solution to form a purified iron-containing feedstock and a used leaching solution; and
solid-liquid separating the purified iron-containing feedstock from the used leaching solution,
wherein an amount of aluminum, silicon, or a combination thereof is less in the purified iron-containing feedstock than in the iron-containing feedstock.

2. The method of claim 1, wherein a weight ratio of the flux to the pretreated iron-containing feedstock is less than or equal to 1.5:1.

3. The method of claim 1, wherein the metal of the metal borate is an alkali metal, an alkaline earth metal, or a combination thereof.

4. The method of claim 1, wherein the metal borate is Na₃BO₃, Na₃B₃O₆, NaB(OH)₄, Na₂B₄O₇, Na₂B₄O₇·4H₂O, Na₂B₄O₇·5H₂O, Na₂B₄O₇·10H₂O, Na₂B₈O₁₃, or a combination thereof.

5. The method of claim 1, wherein the flux further comprises a second fluoride salt, a second chloride salt, a hydroxide, or a combination thereof, and optionally wherein the second fluoride salt is ammonium fluoride, an alkali metal fluoride, an alkaline earth metal fluoride, or a combination thereof, and the second chloride salt is ammonium chloride, an alkali metal chloride, an alkaline earth metal chloride, or a combination thereof.

6. The method of claim 1, wherein the fusing comprises heating at a temperature of 323° C. to 1500° C. for 1 hour to 24 hours.

7. The method of claim 1, wherein the leaching solution is water, and optionally the water has a temperature of 25° C. to 300° C.

8. The method of claim 1, wherein the leaching solution is
(i) an acidic aqueous solution; or
(ii) an acidic aqueous solution comprising hydrofluoric acid, hydrochloric acid, nitric acid, sulfuric acid, acetic acid, citric acid, oxalic acid, or a combination thereof.

9. The method of claim 1, wherein the leaching solution is
(i) a basic aqueous solution; or
(ii) a basic aqueous solution comprising sodium hydroxide, potassium hydroxide, lithium hydroxide, cesium hydroxide, ammonium hydroxide, or a combination thereof.

10. The method of claim 1, further comprising recycling one or more components of the flux from the used leaching solution.

11. A method of removing one or more impurities from an iron-containing feedstock, the method comprising:
grinding the iron-containing feedstock in the presence of a grinding aid to provide a pretreated iron-containing feedstock, the grinding aid comprising an alkali metal chloride, a fluoride salt, or a combination thereof;
contacting the pretreated iron-containing feedstock with an acid solution to form a purified iron-containing feedstock and a used acid solution, the acid solution comprising 1 wt % to 20 wt % of an inorganic acid having a pKa of less than −1, an organic acid, or a combination thereof, based on a total weight of the acid solution; and
solid-liquid separating the purified iron-containing feedstock from the used acid solution,
wherein an amount of aluminum, silicon, or a combination thereof is less in the purified iron-containing feedstock than in the iron-containing feedstock.

12. (canceled)

13. (canceled)

14. The method of claim 11, wherein the acid solution comprises hydrochloric acid, nitric acid, sulfuric acid, acetic acid, citric acid, oxalic acid, or a combination thereof.

15. (canceled)

16. A method of removing one or more impurities from an iron-containing feedstock, the method comprising:
grinding the iron-containing feedstock in the presence of a grinding aid to form a pretreated iron-containing feedstock, the grinding aid comprising an alkali metal chloride, a fluoride salt, or a combination thereof;
contacting the pretreated iron-containing feedstock with a caustic solution having a hydroxide concentration of at least 30 wt % at a temperature of at least 90° C. to form a purified iron-containing feedstock and a used caustic solution, the caustic solution and the iron-containing feedstock having a ratio of at least 2.5 mL/g; and
solid-liquid separating the purified iron-containing feedstock from the used caustic solution,
wherein an amount of aluminum, silicon, or a combination thereof is less in the purified iron-containing feedstock than in the iron-containing feedstock.

17. The method of claim 16, wherein the contacting is at a temperature of 140° C. to 300° C. for 30 minutes to 24 hours.

18. The method of claim 16, wherein the caustic solution comprises sodium hydroxide, potassium hydroxide, lithium hydroxide, cesium hydroxide, ammonium hydroxide, or a combination thereof.

19. The method of claim 16, further comprising purifying the used caustic solution to form a purified caustic solution before further contacting the purified caustic solution with the pretreated iron-containing feedstock.

20. The method of claim 19, wherein the purifying comprises contacting the used caustic solution with Al₂O₃, Al(OH)₃, CaO, Ca(OH)₂, an aluminate compound, or a combination thereof; and optionally wherein the aluminate compound comprises NaAlO₂, Al₂Si₂O₅(OH)₄, NaAl(OH)₄, Na₂O·Al₂O₃, Na₂Al₂O₄, or a combination thereof.

21. (canceled)

22. The method of claim 1, wherein the grinding aid is solid sodium chloride.

23. The method of claim 1, wherein a weight ratio of the grinding aid to the iron-containing feedstock is 1:8 to 1:1.

24. The method of claim 1, wherein the grinding releases one or more impurities from a matrix of the iron-containing feedstock.

25. The method of claim 1, wherein
(i) the pretreated iron-containing feedstock comprises iron-containing feedstock particles having an average particle size of 10 μm to 300 μm;
(ii) the iron-containing feedstock comprises hematite, maghemite, magnetite, goethite, limonite, or a combination thereof;
(iii) the method further comprises washing the purified iron-containing feedstock with an aqueous solution; or
(iv) a combination thereof.

26. The method of claim 1, wherein
(i) the purified iron-containing feedstock comprises at least 10 weight percent less aluminum than the iron-containing feedstock, based on a total weight of the aluminum in the iron-containing feedstock;
(ii) the purified iron-containing feedstock comprises at least 10 weight percent less silicon than the iron-containing feedstock, based on a total weight of the silicon in the iron-containing feedstock;
(iii) a total content of silicon and aluminum in the purified iron-containing feedstock is less than 6 wt %, based on a total weight of the purified iron-containing feedstock; or
(iv) a combination thereof.

27. A purified iron-containing feedstock, prepared by the method of claim 1.

28. A method comprising:
removing one or more impurities from an iron-containing feedstock to form a purified iron-containing feedstock by the method of claim 1; and
electrochemically producing an iron metal from the purified iron-containing feedstock.

29. The method of claim 28, wherein the iron metal has
a specific total embedded emissions of less than 0.8 tons of CO₂ per ton of the iron metal, when determined according to the European Union simplified bubble approach method for determining specific embedded emissions under the Carbon Border Adjustment Mechanism;
a carbon emission intensity of less than 1100 kilograms of CO₂ per ton of the iron metal, when determined according to ISO 14404;
a carbon emission intensity of less than 800 kilograms of CO₂ per ton of the iron metal, when determined according to the Intergovernmental Panel on Climate Change Methodology 2006 Guidelines for National Greenhouse Gas Inventories;
a carbon emission intensity of less than 1500 kilograms of CO₂ per ton of the iron metal, when determined according to the 2017 World Steel Life Cycle Inventory Methodology;
a carbon emission intensity of less than 1300 kilograms of CO₂ per ton of the iron metal, when determined according to the 2008 World Resource Institute Iron and Steel Greenhouse Gas Protocol;
a carbon emission intensity of less than 750 kilograms of CO₂ per ton of the iron metal, when determined according to European Union Commission Implementing Regulation 2018/2066;
a specific total embedded emissions of less than 0 tons of CO₂ per ton of the iron metal, when determined according to the European Union simplified bubble approach method for determining specific embedded emissions under the Carbon Border Adjustment Mechanism, or a combination thereof.
